(19) United States
(12) Patent Application Publication
(10) Pub. No.: US 2017/0043212 A1
(43) Pub. Date: Feb. 16, 2017

(54) SYSTEM AND METHOD FOR ANALYZING STROKING MOTIONS IN WATER SPORTS

(71) Applicant: PLATYSENS LIMITED, Hong Kong (HK)

(72) Inventors: Cheong Yui WONG, Hong Kong (HK); Wan Ming LAU, Hong Kong (HK); Wing Kit Andrew TSANG, Hong Kong (HK)

(73) Assignee: PLATYSENS LIMITED, Hong Kong (HK)

(21) Appl. No.: 14/974,973

(22) Filed: Dec. 18, 2015

(30) Foreign Application Priority Data
Aug. 11, 2015 (HK) 15107765.1

(51) Int. Cl. A63B 24/00; A63B 69/06; A63B 69/12; H04L 29/08; G09B 19/00

(52) U.S. Cl. CPC A63B 24/0003; H04L 67/12; G09B 19/0038; A63B 24/0075; A63B 69/12; A63B 69/06; A63B 2069/068; A63B 2220/50; A63B 2220/30; A63B 2220/62; A63B 2220/803; A63B 2208/03

(57) ABSTRACT

A method and a system is disclosed for analysing a stroking motion in a water sport by using one or a plurality of sensing devices for generating physical measurements of the stroking motion, a computing device provided with a mobile application for receiving transmitted data of metrics from the sensing device, and a remote server capable of communicating with the mobile application to facilitate upload of the received metrics data to the remote server. The remote server is fashioned to compare the uploaded metrics to a set of values corresponding to predefined athletic data to produce results in terms of force used per time and to determine an optimised stroking motion.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The invention relates to a method for analyzing stroking motions in water sports. More particularly, the invention pertains to a simple and direct method for analyzing strength and effectiveness of the stroking motions. The invention is also provided with a system being capable of generating measurements, storing and transmitting data, analyzing the stroking motions based on the data and connecting to a remote server which is configured to perform further analyses.

2. Description of Related Art Including Information Disclosed Under 37 CFR 1.97 and 37 CFR 1.98

It is well known in the art that amateur and professional athletes collect data, both in training and in competition, and subsequently analyse the collected data, thereby allowing the athletes and their trainers to monitor, to evaluate as well as to assist in improving their performances. Correspondingly, it creates high demand for training equipment and methodology.

U.S. Pat. No. 7,272,499 (B2) and 7,715,982 (B2) disclose a method and a system for monitoring performance characteristics of athletes in general and also athletes in watercraft and in water sports such as rowing, kayaking, surf-ski riding and sailing. Particularly, the invention is provided with a system that incorporates a movement sensor which is preferably an accelerator or a gyrosensor, an impeller or flow sensor to sense velocity, a GPS unit which may be combined with the accelerator to sense position and velocity, a heart rate monitor, a controller programmed to manipulate the data and provide a display of the heart rate, boat speed, stroke rate, etc. The data can be stored or transmitted to a remote computer for use by the coach.

U.S. Pub. No. 2012/0072165 (A1) discloses a system and a method for observing a swimming activity of a person. The system includes a waterproof housing having a motion sensor which can be a tri-axial accelerator, a gyrometer or a magnetometer, and is furnished with fixing means for securely fastening the housing to a part of the body of a user, particularly to the wrist, the ankle, the neck or the head of a user. The system also comprises an analysis means for analysing the signals transmitted by the motion sensor and adapted for determining the type of swimming of the user as a function of time by using a hidden Markov model with N states corresponding respectively to N types of swimming By employing such system, it allows the user or the swimmer to accurately determine the succession of swimming types that he has undertaken during his session.

WIPO Intl. Pub. No. 2013/084230 (A1) discloses a system and a method for tracking a trajectory of a paddling movement such as a paddle or an oar and/or for computing a paddling force and/or for determining a strategy to improve paddling. Particularly, the system comprises a position sensor configured for mounting on a paddling instrument and a processor configured for computing a trajectory of the paddling instrument from an output of the position sensor. It should be noted that in this invention, the sensor may be an accelerometer, a motion detector, a magnetic sensor, a gravimeter, a gyro, a GPS receiver, a strain gauge and/or a flow meter. The system may also include a second position sensor mounted on a boat. Correspondingly, the processor is further configured for computing a trajectory of the paddling instrument with respect to the boat.

Although a variety of training equipment and methodology has been disclosed, it should be noted that they have not been provided with a capability for communicating with a server to compare the information relating to the athlete's performance to a database on which a plurality of athletic data is stored. Furthermore, the performance feedback provided by the existing equipment to the athlete often fails to furnish the athletes or their trainers with insightful information which would enable them to devise or develop strategies for improving future performances upon comparison to the past performances. Therefore, there remains a need for providing an improved system and method for analysing stroking movements performed by an athlete and monitoring the athlete's performance.

According to the present invention, not only it allows the communication between sensors, computing devices and a remote server to generate insightful information for the athletes or their trainers, but it also provides an alternative approach for improving reliability, accuracy and reproducibility of the generated results. It can be achieved by measuring the physical attributes (such as acceleration, rotation, pressing force against water, etc.) using sensing devices which are specially designed by the inventor. For instance, the pressing force against water can be measured as a voltage across a force sensing resistor in the sensing device, wherein the voltage corresponds to the pressing force upon reference to a pre-computed data. A total force exerted by the athlete can then be estimated by taking the product of the force and a factor. Accordingly, by using the data as measured by the sensing devices, it helps to ensure the reliability and accuracy of the results as generated in this invention.

### BRIEF SUMMARY OF THE INVENTION

One of the objects of the invention is to provide a simplified method for analysing stroking motions in a water sport. More specifically, the method involves interactive communication between one or a plurality of sensors, a mobile computing device and a remote server, and it also allows data obtained from the sensors to be converted to desirable metrics and compare the metrics to a plurality of athletic data to identify an optimized stroking motion.

Another object of the invention is to provide a method that is capable of improving reliability, accuracy and reproducibility of the generated results. It can be achieved by measuring the physical attributes (such as acceleration, rotation, pressing force against water, etc.) using a plurality of sensing devices specially designed by the inventor.

Still another object of the invention is to provide a method that enables an athlete and/or a trainer to understand both strengths and weaknesses of the stroking motions based on the comparative analysis between the metrics and the plurality of athletic data, which then allows him to devise strategies for improving future performances.

A further object of the invention is to develop a system for analysing stroking motions in a water sport, which involves interactive communication between one or a plurality of sensors, a computing device and a remote server.

Still another object of the invention is to introduce a system capable of producing results with better reliability, accuracy and reproducibility. In order to achieve this, the physical attributes (such as acceleration, rotation, pressing force against water, etc.) using a plurality of sensing devices which are specially designed by the inventor.

Yet another object of the invention is to develop a system provided with one or more sensors, the sensors being attached to paddling instruments or provided with straps or other appropriate fastening means to fasten the sensors to palms or fingers of athletes performing the stroking motions.

Still another object of the invention is to introduce a system for analysing stroking motions, the system being provided with devices capable of converting data measured by the sensors to desirable metrics and then performing comparative analyses based upon the metrics. It thus enables a user to monitor the athletic performance as well as to devise strategies for improving future performances.

Yet another object of the invention is to introduce a system capable of displaying metrics useful for monitoring athletic performance, for instance, stroke power, stroke angle, stroke length, power distribution, percentage of time that the stroking object is pressing against water, moving speed etc. The system is capable of allowing the athlete or his trainer to identify different phases of the stroking motion, namely pull-push, recovery and idle.

At least one of the preceding objects is met, in whole or in part, by the invention, in which one of the embodiments of the invention describes a system for analysing a stroking motion in a water sport comprising one or a plurality of sensing devices, each sensing device comprising at least one sensor for generating physical measurements of the stroking motion, the sensor being selected from the group consisting of an accelerometer, a force sensing resistor, a gyroscope and a magnetometer; and a processor, in connection with the sensor, provided with a memory unit and a wireless communication module, wherein the processor is fashioned to receive a signal through the wireless communication module to switch the sensing device in between a first and a second operating mode; wherein in the first operating mode, the sensing device is configured to convert the physical measurements to metrics and immediately transmit the data relating to the metrics, whereas in the second operating mode, the sensing device is configured to, after the conversion, store the metrics in the memory unit first and then transmit the data of the metrics through the wireless communication module upon receiving a second signal; a computing device provided with a mobile application for receiving the transmitted data of the metrics from the sensing device; a remote server capable of communicating with the mobile application to facilitate upload of the received metrics data to the remote server; wherein the remote server is fashioned to compare the uploaded metrics to a set of values corresponding to predefined athletic data to produce results in terms of force used per time and to determine an optimised stroking motion.

Preferably, the physical measurements generated by the sensors are selected from the group consisting of acceleration, rotation and pressing force against water, whilst the metrics obtained from the converting step can be selected from the group consisting of stroke power, stroke angle, stroke length and moving speed.

It is also preferred that the remote server is a cloud server for performing comparative analyses between the metrics obtained from the converting step and the athletic data.

In another preferred embodiment of the invention, the sensing device is also provided with an external power source for supplying electrical power to the processor.

In addition, the sensing device further comprises a high pass filter for removing drifts in the data of the metrics. Alternatively, the accelerometer and the gyroscope are each provided with a high pass filter to remove possible drifts present in the measurements.

In still another preferred embodiment of the invention, the sensing device and the mobile application are each provided with a local real time clock for marking each generated physical measurements with a time-stamp and so, it is crucial to ensure that these clocks are calibrated to be in synchronization.

A further embodiment of the invention describes a method for analysing a stroking motion in a water sport, such as swimming, rowing, canoeing, kayaking or dragon-boating, comprising the steps of securing one or a plurality of sensing device containing at least a force sensing resistor on an athlete's finger or palm by using a fastening means; and generating physical measurements of the pressing force against water of the stroking motion.

In another further embodiment of the invention, the method further comprises the steps of generating physical measurements of at least one factor selected from a group consisting at least one of acceleration, rotation and duration; converting the physical measurements into metrics selected from the group consisting of stroke power, stroke angle, stroke length, moving speed, time to perform one cycle of a stroking motion, stroking cadence, proportion of the total value of power used for the stroking movement and percentage of time that the stroking object is pressing against water; storing the data relating to the metrics in the memory unit; transmitting the data relating to the metrics from the sensing device to a computing device provided with an application; visualising the metrics and creating a force profile based on the metrics; and displaying the metrics and the visualised metrics and the force profile on the computing device. Preferably, the generating step further includes passing the data through a high pass filter to remove possible drifts.

Still another further embodiment of the invention discloses that the method further comprises the steps of uploading the data related to the metrics from the computing device to a remote server;

comparing, on the remote server, the uploaded data to a set of values corresponding to predefined athletic data to produce results identifying weakness, strength or effectiveness of the stroking motion; and determining an optimised stroking motion. The remote server used to perform the comparing step is preferably a cloud server.

The method further comprise the steps of synchronising local real time clocks in the sensing devices and the application on the computing device; and marking each physical measurement generated by the sensing devices with a time-stamp, after the generating step.

One skilled in the art will readily appreciate that the invention is well adapted to carry out the aspects and obtain the ends and advantages mentioned, as well as those inherent therein. The embodiments described herein are not intended as limitations on the scope of the invention.

### BRIEF DESCRIPTION OF THE SEVERAL VIEWS OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a schematic layout of a sensing device according to the preferred embodiment.

FIG. 2a is a graphical illustration of a sensing device.

FIG. 2b shows a sensing device secured on an athlete's finger.

FIG. 2c shows a sensing device secured on an athlete's palm.

FIG. 2d shows another sensing device secured on the athlete's palm.

FIG. 2e shows a sensing device secured on a paddling instrument.

FIG. 3 is an exploded view of a force sensing resistor.

FIG. 4 is a flow diagram illustrating data transmission if the sensing device operates in a real time mode.

FIG. 5a visualizes a comet shaped object based on results obtained from a good paddling technique.

FIG. 5b visualizes a spherical object based on results obtained from a poor paddling technique.

FIG. 6 is a force profile to be displayed on a mobile application installed on a computing device or a mobile phone.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the invention and it is envisioned that those skilled in the art may devise various modifications without departing from the scope of the appended claim.

The invention provides a simple and direct method, and a system, for analyzing a stroking motion in a water sport. More particularly, both the method and the system involve interactive communication between one or a plurality of sensing devices, a mobile computing device and a remote server, which thus allows data storing and transmission and comparative analyses to be performed on the server to analyse the strength and effectiveness of the stroking motion.

It should be appreciated that the method and the system described herein are applicable in a water sport that propels oneself or a boat forward by pressing against water, such as but not limited to swimming, rowing, canoeing, kayaking and dragon-boating. Additionally, the term “stroking motion”, “paddling motion”, “rowing motion”, “propelling motion” or any like term can be used interchangeably herein throughout the description and shall refer to a stroke that can be divided into four phases (namely, catch, drive, finish and recovery) or more or fewer than the four phases.

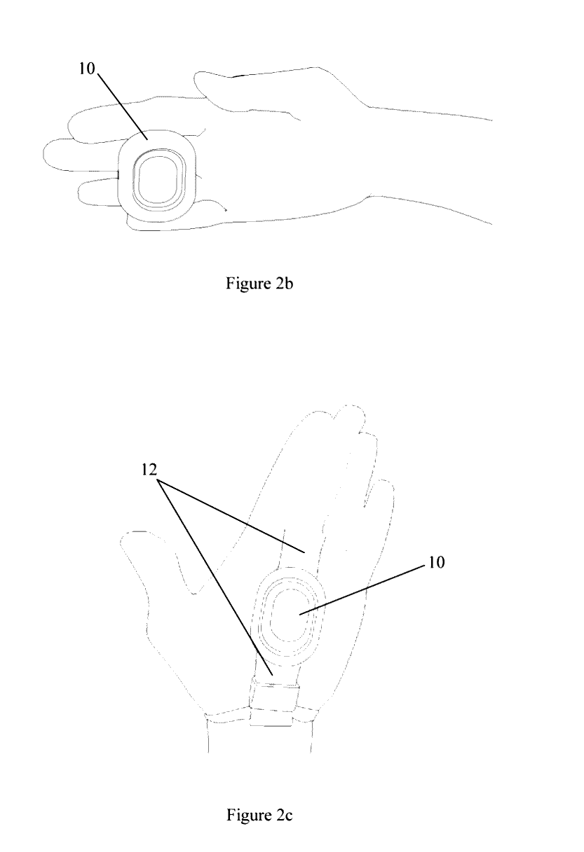

According to the preferred embodiment of the invention, the system for analyzing a stroking motion in a water sport involves one or a plurality of sensing devices (10). Depending on the type of water sport, the sensing devices (10) may be located at different positions. For instance, for water sports like swimming, the sensing device (10) may be provided with a fastening means (12), preferably straps, to secure the sensing device (10) on the athlete's finger as shown in FIG. 2b or on his palm with one end of the fastening means (12) surrounding the wrist of the athlete and the other end securing on one of the athlete's fingers, as illustrated in FIG. 2c. Alternatively, the sensing device (10) may be secured on the palm of the athlete by any appropriate fastening means (12) or straps, as shown in FIG. 2d. On the other hand, for water sports that involve paddling instruments (20), the sensing devices (10) may be mounted on the paddling instruments (20) or oars by means of straps or adhesives. Based on the user's preference, the sensing device (10) may be attached on the blade of the paddling instrument (20), as shown in FIG. 2e.

Referring now to FIG. 2a, the sensing device (10) comprises multiple electronic components contained in a hard, rigid waterproof housing (11). As the term “waterproof housing” is used herein, it is meant to refer to the housing (11) made of a waterproof material, or other housing with a coating or a cover to protect the components contained therein by substantially resisting ingress of water. Inside the housing (11), the sensing device (10) comprises at least one sensor for generating physical measurements of the stroking motion. The sensor can be selected from the group consisting of an accelerometer (101) (also known as “G-sensor”) for measuring single- or multi-axial acceleration, a force sensing resistor (FSR) (102) for measuring resistance changes when a force or pressure is applied, a gyroscope (103) for measuring orientation or rotation, and a magnetometer for measuring magnetization of a magnetic material or its strength. Accordingly, the physical measurements generated may be acceleration, rotation and pressing force against water. Nevertheless, the sensors used in this invention shall not be limited thereto or thereby, as other types of sensors can be employed based on the desired physical measurements for monitoring the athletic performance.

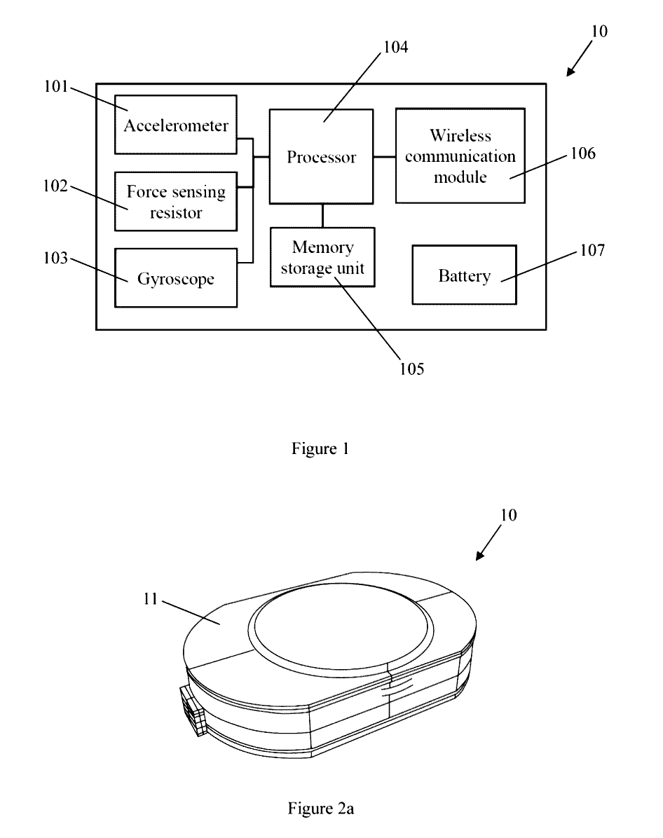

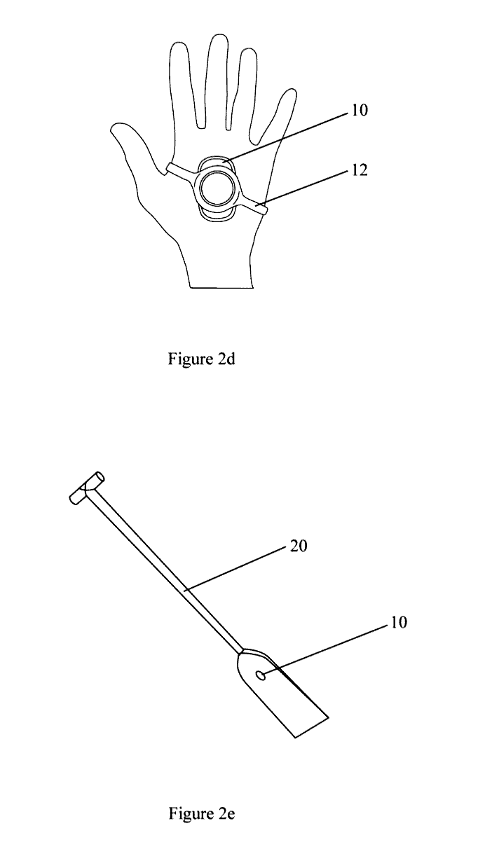

In a more preferable embodiment, the sensing device (10) comprises a plurality of sensors, which are a G-sensor (101), a FSR (102) and a gyroscope (103), as illustrated in FIG. 1. The FSR (102), as shown in FIG. 3, comprises an electronic circuit board (1021) with finger-like electrode (not shown), a layer of FSR material (1022) on top of the circuit board (1021) and an actuator placed above the FSR material, wherein the actuator is made up of a soft layer (1023) and a hard layer (1024). The hard layer (1024) can be made of any material including plastic and metal, whilst the soft layer (1023) is preferably made of rubber, silicone rubber, foam or other polymeric material. Before the FSR (102) is being employed, a pre-loading force is applied to the actuator to bring the resistance of the FSR (102) to a few hundred kOhm, preferably 100 to 200 kOhm. Such calibration step is crucial as it produces the sensitivity needed for sensing force when pressing water.

In an alternative embodiment, the accelerometer (101) and the gyroscope (103) may be combined and present as a unit. Correspondingly, the sensing device (10) comprises a pair of sensors: one of which is the FSR (102) and the other is a motion sensing unit capable of functioning as the gyroscope (103) and the accelerometer (101) either simultaneously or on an individual basis based on the user preference.

The sensing device (10) may also include a processor (104). As shown in FIG. 1, the sensors are connected to the processor (104). As soon as data relating to the physical measurements are generated by the sensors, they are transferred to the processor (104) which performs first level of analysis where the data are converted to the desirable metrics relating to human movement. Preferably, the metrics are selected from at least one from the group consisting of stroke power, stroke angle, stroke length and moving speed.

It is also preferred in this invention that the sensing device (10) comprises a wireless communication module (106) connected to the processor (104), as illustrated. Presence of the wireless communication module (106) is essential as it facilitates transmission of the metrics from the processor (104) to another destination such as but not limited to a computing device, an external memory storage unit or an external server. It should also be appreciated that any type of the wireless communication module (106) can be used in this invention, such as a Bluetooth module, a Bluetooth low energy (BLE) module, a WIFI module, an ANT module, an ANT+ module or a Zigbee module. Depending on the selected wireless networking technology, the data are then transmitted through the wireless network at the required frequency range. Furthermore, the wireless communication module (106) may be configured to receive instruction signals from the user which subsequently trigger the processor (104) to transmit, or to stop transmitting, the data.

It should be appreciated that although it has been illustrated in the accompanying drawings that the wireless communication module (106) is a separate component from the processor (104), this invention should, however, not be limited thereto or thereby, as it can be an integral part to the processor (104), depending on the user preference.

In another preferred embodiment of the invention, the sensing device (10) is provided with an external power source (107), such as a battery, for supplying electrical power to the processor (104). The sensing device (10) may also be provided with a memory unit (105) to thereby allow the results from the first level of analysis, particularly the metrics, to be stored thereon.

Presence of both the wireless communication module (106) and the memory unit (105) in the sensing device (10) enables it to function in either a first operating mode or a second operating mode. More particularly, the wireless communication module (106) present in the sensing device (10) is configured to receive a signal from the user which subsequently triggers the sensing device (10) to function in a preferred operating mode, either the first or the second operating mode.

In the first operating mode or also known as “real time mode”, the sensing device (10) is fashioned such that as soon as the metrics are obtained from the conversion of the physical measurement by the processor (104), they are transmitted to a computing device through the wireless communication module (106), without the need to store in the memory unit (105). It is worth noting that in this mode, the data is constantly transmitted throughout the training. On the other hand, when in the second operating mode or also known as “storage mode”, the sensing device (10) is configured to store the metrics in the memory unit (105) first, once obtained from the processor (104). The metrics stored in the memory unit (105) will only be transferred upon receiving a second signal sent after the training.

Further, the sensing device (10) is allowed to change its mode of operation from the real time mode to the storage mode, or from the storage mode to the real time mode, upon receiving a signal corresponding to mode changing commands through the wireless communication module (106).

By enabling the sensing device (10) to operate in different modes, it is thus able to fulfil different needs of the user, the athlete or the trainer. For swimming where the athlete is not able to check the metrics whilst training, the sensing device (10) is configured to operate in the storage mode where data are stored in the memory unit (105) and transmitted to the computing device after training. On the contrary, for the paddling water sports where the athletes can check the metrics whilst training, real time mode is preferred so that the data is transmitted from the sensing device (10) to the computing device during the training to provide real time feedback to the athlete and/or the trainer.

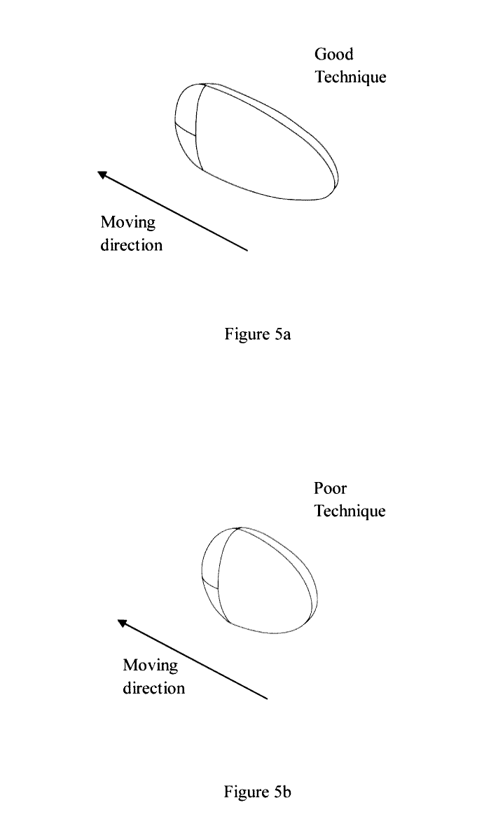

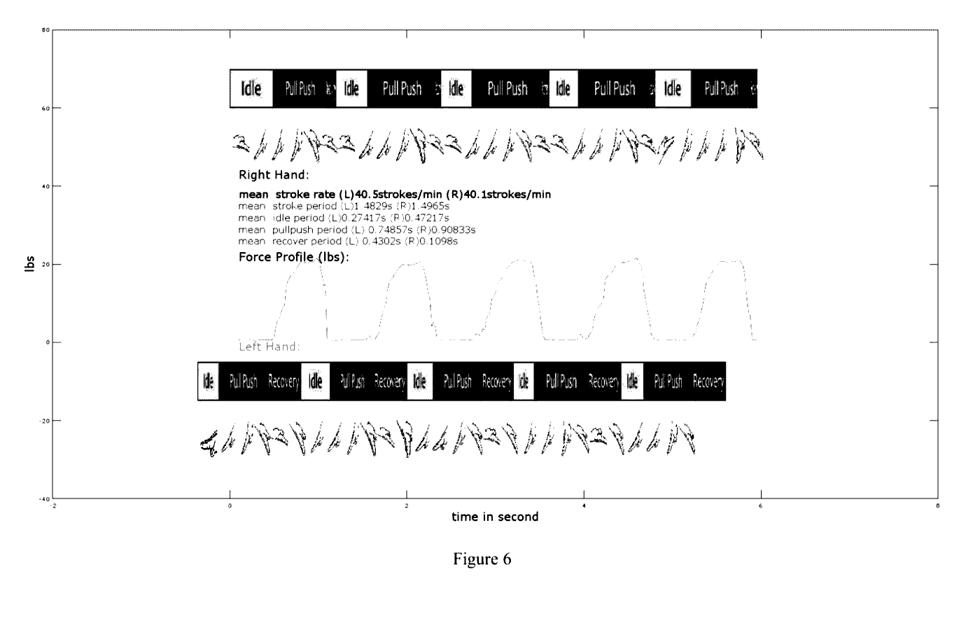

In accordance with the preferred embodiment of the invention, the sensing device (10) is capable of communicating with a computing device which in this invention is preferably mobile, such as a mobile phone, a tablet and a portable personal computer (also known as a laptop). However, in the interest of the inventor, the computer device is hereinafter referred specifically to as the mobile phone. Additionally, it is of importance to note that the computing device, particularly the mobile phone, is provided or installed with a mobile application where the metrics transmitted from the processor of the sensing device (10) are displayed. It is also of particular interest to connect the mobile phone to a remote server wirelessly, or in a wired connection based upon the user's preference. Through the mobile application, it allows the user, the athlete or the trainer to transfer, or upload, the metrics to the remote server for second level of analysis, or further analysis. In another preferred embodiment, the mobile application may be configured to display results in a visual form based on the data corresponding to the computed power values. The displayed results visualises the power distribution, particularly how the forces are exerted in each direction. The results may be visualised as an irregular shaped object in which the length of each axis represents the power of each stroking motion. A good paddling technique produces a comet-like shape, as illustrated in FIG. 5a. On the other hand, if the paddling technique is poor, it may appear as a sphere as shown in FIG. 5b. Besides the power distribution, the mobile application may also be configured to display force profile, as shown in FIG. 6, which may subsequently allow the athlete or his trainer to identify the phases of the stroking motion, namely pull-and-push, recovering and idle phases. For instance, the force profile as illustrated in FIG. 6 may be displayed as a graph of force against time, with the force being that generated by the stroking motion as performed by a swimmer The force may gradually develop and reach a maximum value when the swimmer is performing pull-and-push stroke. The force then decreases significantly when a recovering stroke is performed. Insignificant or no force will be detected when the hands or the arms of the swimmer are in the air (also known as the idle phase).

It should be appreciated that the remote server to which the mobile phone is connected is preferably a cloud server. The cloud server is fashioned so that after the metrics are uploaded, second level of analysis can be performed. Specifically, the second level of analysis is a comparative analysis where the uploaded metrics are compared to a set of values corresponding to predefined athletic data, so as to identify the weakness, strength or effectiveness of the stokes. Strategies for improving future performances can be devised thereafter.

It should also be appreciated that the sensing device and the mobile application may each include a local real time clock. Particularly, when more than one sensing device (10) is employed, it is important to ensure that the clocks are all calibrated to be in synchronisation.

As depicted in the foregoing, it should be noted that the cloud server comprises a database containing a set of values corresponding to predefined athletic data. The predefined athletic data used to establish the database may be measurements or data collected during the athlete's training sessions, and it can be helpful when comparing to the athlete's prior performance or across different athletes of the same team for water sports such as rowing, canoeing or dragon-boating. Alternatively, the database may be built using the data corresponding to optimal movement for a particular sport. In particular, the data is obtained by recording the measurements relating to the strokes performed by professional athletes. Correspondingly, upon comparison to the data relating to the optimum stroking movements performed by the professional athletes, the user or the trainer can devise training drills for improvement.

A further embodiment of the invention is a method for analysing a stroking motion in a water sport, in which the method is assisted by employing the sensing device (10), the mobile phone and the cloud server, as depicted in the foregoing. Preferably, the method begins as soon as the athlete with the sensing device (10) fastened on his finger or palm, or attached to his paddling instrument (20), starts his training. Firstly, physical measurements of the strokes are generated using at least one sensor on the sensing device, in which the sensor can be selected from at least one of a G-sensor (101), a FSR (102), a gyroscope (103) and a magnetometer. Accordingly, the physical measurements generated may be acceleration, rotation and pressing force against water. In a more preferable embodiment, the sensing device (10) comprises a plurality of sensors, which are a G-sensor (101) for measuring single- or multi-axial acceleration, a FSR (102) for measuring the pressing force against water, and a gyroscope (103) for measuring orientation or rotation. Alternatively, the sensing device (10) may comprise a pair of sensors, one of which for measuring the pressing force against water and another for measuring the acceleration and orientation or rotation, either simultaneously or separately according to the user setting.

According to the further embodiment of the invention, the sensing device (10) comprises an accelerometer (101), a FSR (102) and a gyroscope (103) to measure acceleration, force and rotation or orientation respectively. For instance, the FSR (102) is configured to measure the voltage across the resistor and correspondingly, a force is obtained by using the voltage, upon reference to a pre-computed table which lists the relationship between the force and the voltage. A total force exerted by the athlete can then be estimated by taking the product of the force and a factor. For swimming, the factor may be a ratio of the area of the sensing device (10) to that of the athlete's palm and forearm. If the water sports involve paddling, the factor may refer to the ratio of the area of the sensor to that of the paddle. On another hand, the gyroscope (103) is used to produce data or measurements relating to the orientation, where the measured data is first integrated to obtain angle rotated in x-, y- and z-axis with respect to proper initial position. A high pass filter may also be provided to the gyroscope to remove possible drifts present in the data. While the accelerometer (101) is used, it is configured to produce measurements pertaining to the acceleration, velocity and displacement. Specifically, the measured data refers to the acceleration in x-, y- and z-axis, which may be integrated to obtain velocity in each axis with respect to proper initial position, or integrated twice to obtain displacement in each axis. One or more high pass filters may also be provided to the accelerometer (101) in order to remove possible drifts present in the integrated data.

Subsequently, the generated data corresponding to the physical measurements of the strokes are transferred to the processor (104) for performing the first level of analysis, particularly for converting the physical measurements to metrics relating to human movement. The metrics may be selected from at least one from the group consisting of stroke power, stroke angle, stroke length and moving speed.

Specifically, by using the physical measurements obtained from the G-sensor (101) and the gyroscope (103), the processor (104) first computes angle of the stroke performed. The result corresponding to the stroke angle may optionally be passed to a high pass filter to remove possible drifts that are present in the signals. The force measured using the FSR (102) can then be resolved into three axes, one of which is along the axis of the movement of the athlete's body or boat and the other two axes perpendicular to the first axis. For each axis, a work value is calculated by taking the integral of force with respect to displacement. This work value is then divided by time to produce a value for power being produced. By taking sum of the power values in all direction, a total power is obtained, where this value represents the power exerted on the stroking motion or on the paddling instrument (20) by the user. Correspondingly, the power along the axis of the movement of the athlete's body or boat is taken as the useful power that helps propelling movement.

Also using the stroke angle as calculated by the processor (104), the acceleration measured by the G-sensor (103) is resolved into three axes. Similarly, one of the axes is along the axis of the movement of the athlete's body or boat and the other two axes are perpendicular to the first axis. For each axis, a velocity value is computed by taking the integral of acceleration over time. Subsequent integral of velocity over time produces a value for displacement. Correspondingly, the displacement along the axis of the movement of the athlete's body or boat is taken as the effective stroke length.

For water sports like swimming where the phone is not carried by the athlete during the training, it is essential to configure the sensing device (10), particularly the processor (104), to estimate the moving speed of the athlete. To estimate the moving speed along the boat or the body's movement axis, the partial results from the stroke length analysis are used to calculate the net velocity.

In another embodiment, the first level of analysis may include cycle estimation. Using the physical measurements obtained from the gyroscope (103), the processor (104) is fashioned to estimate the time for a paddle to perform one cycle. It is also capable of calculating the paddling cadence in a unit of stroke per minute. Furthermore, percentage of time that the paddle is pressing against water can be calculated from this analysis.

After converting the physical measurements to the desirable metrics, the data corresponding to the metrics may be transmitted to either a computing device or a memory storage unit (105), depending on the operation mode of the sensing device (10) as selected by the user, the athlete or the trainer. Preferably, the operation mode of the sensing device (10) is selected before the user or the athlete performs the stroking motions.

For water sports involving paddling instruments (20), it is preferred that the sensing device (10) is configured to operate in a first operating mode, or also known interchangeably as real time mode, where the data with respect to the metrics are transmitted from the processor (104), through a wireless communication module (106) incorporated to the processor (104), to a computing device immediately after the metrics are obtained upon conversion of the physical measurements of each stroke. Particularly, the data relating to the metrics are sent to a mobile application on the computing device which is a mobile phone. Although mobile phone is referred in the description hereinafter, it should be noted that other portable computing device such as a tablet or a laptop may be used in alternative embodiments, depending on the user's preference.

On the mobile application, the data corresponding to the metrics are displayed. The results obtained from the first level of analysis may also be displayed in a visual form. For instance, the results may be illustrated as an irregular shaped object in which the length of each axis represents the power of each stroking motion, as illustrated in FIGS. 5a and 5b. Furthermore, force profile may also be displayed on the mobile application, as shown in FIG. 6.

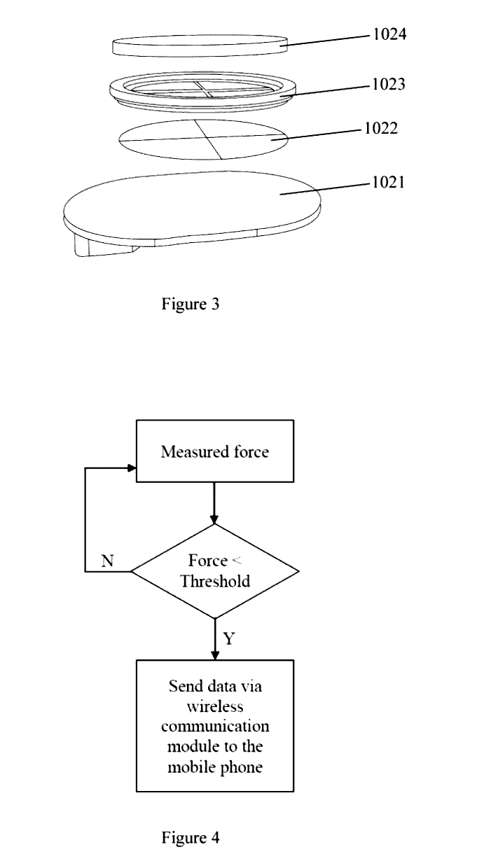

In order to ensure that the data is transmitted in the real time mode from the processor (104) to the mobile application on the mobile phone throughout the training, the force as measured by the FSR (102) is used as a triggering signal to transmit the data relating to the metrics via the wireless communication module (106). As illustrated in FIG. 4, if the measured force is below a predefined threshold, the wireless communication module (106) is activated to transmit the data to the mobile phone. It should be appreciated to note that the predefined threshold indicated herein is determined during field trial testing through a calibration process.

Subsequently, the transmitted metrics are uploaded from the mobile application to a remote server. It should be appreciated to note that the remote server is capable of establishing wireless connection to the mobile phone on which the mobile application is installed. Correspondingly, the wireless connection therebetween enables the user to upload the metrics from the mobile application to the remote server.

Preferably, the remote server depicted in the foregoing is a cloud server where second level of analysis is performed. It should be appreciated to note that the second level of analysis is a comparative analysis in which the uploaded metrics are compared to a set of values corresponding to predefined athletic data, to identify the weakness, strength or effectiveness of the stokes, and to determine an optimized stroke. Particularly, the comparative analysis is able to demonstrate results in terms of force used over time. Alternatively, for water sports using paddling instruments (20), it is desired to compare the time, stroke angle, force amplitude and force profile i.e. how force level changes over many cycles. These indications can later be used by the less skilled users to devise strategies for improving future performances.

With reference to the preceding description, it should be noted that the cloud server comprises a database containing a set of values corresponding to predefined athletic data. The predefined athletic data used to establish the database may be measurements or data collected during the athlete's training sessions, and it can be helpful when comparing to the athlete's prior performance or across different athletes of the same team for water sports such as rowing, canoeing or dragon-boating. Alternatively, the database may be built using the data corresponding to optimal movements for a particular sport. Specifically, the data is obtained by recording the measurements relating to the strokes performed by professional athletes. Upon comparison to the data relating to the optimum strokes performed by the professional athletes, the user or the trainer can devise training drills for improvement.

On the other hand, for water sports like swimming, the sensing device (10) is preferably configured to operate in a second operating mode, or also known interchangeably as storage mode, in which the data corresponding to the metrics are stored in a memory unit (105) upon obtaining from the processor (104) and the stored metrics will be transmitted to the mobile application on the mobile phone after the training. More particularly, after the training session, a triggering signal is generated by the mobile application and sent to the sensing device, in order to initiate the data transmission from the processor to the mobile application.

Like when operating in the real time mode, the data corresponding to the metrics can be displayed on the mobile application. The results obtained from the first level of analysis may be displayed in a visual form, as an irregular shaped object in which the length of each axis represents the power of each stroking motion, as illustrated in FIGS. 5a and 5b. Furthermore, force profile may also be displayed on the mobile application, as shown in FIG. 6.

After the metrics are uploaded from the mobile application to the cloud server, second level of analysis is performed. It is worth noting that the second level of analysis is a comparative analysis where the uploaded metrics are compared to a set of values corresponding to predefined athletic data. Results obtained from the comparative analysis, in terms of force used per time, then assist the user to identify the weakness, strength or effectiveness of the stokes, particularly to determine an optimized stroke. Upon identifying the optimized stroking motion, strategies for improving future performances can be devised thereafter.

Similarly, in this embodiment, the cloud server comprises a database containing a set of values corresponding to predefined athletic data. The predefined athletic data used to establish the database may be measurement data collected during the athlete's training sessions or data corresponding to optimal movement for a particular sport.

It should be appreciated that the sensing device (10) is allowed to change its mode of operation from the real time mode to the storage mode, or from the storage mode to the real time mode, upon receiving mode changing commands through the wireless communication module (106).

It should also be appreciated that throughout this description, any type of the wireless communication module (106) can be employed to incorporate to the processor (104), such as a Bluetooth module, a Bluetooth low energy (BLE) module, a WIFI module, an ANT module, an ANT+ module or a Zigbee module. Depending on the selected wireless networking technology, the data are then transmitted through the wireless network at the required frequency range.

In another preferred embodiment of the invention, the sensing device (10) and the mobile application are each provided with a local real time clock. Presence of these real time clocks is crucial as more than one sensing device (10) is employed in this invention. For example, for swimming, the athlete is required to fasten a sensing device on his left hand and another on the right hand, whilst for other water sports such as rowing, canoeing, kayaking and dragon-boating, each paddling instrument (20) will be provided with a sensing device (10). In the water sports that involve paddling instruments (20), pressing the paddling instruments (20) by the crews simultaneously is crucial with respect to the speed of the boat, whilst in swimming, the stroking duration spent on each arm should be approximately the same. Therefore, the real time clocks are provided to the sensing devices (10) to monitor the paddling duration.

It is important to calibrate the clocks on the sensing devices (10) and that on the mobile application to ensure that they are all in synchronisation. More particularly, before the activity starts, a signal, or signals, is sent from the mobile phone through the mobile application to the sensing devices (10). The signals indicated herein may include a signal representing real time in the units of date, hour, minute and second and a signal for resetting a counter incrementing at 100 Hz in the sensing device (10). Subsequently, the physical measurements collected by the sensing devices (10) are marked with a time-stamp (or specifically, the count of the 100 Hz counter) using the synchronised clocks and then sent to the computing device or the mobile phone. Upon receiving the data from the processor (104), the mobile application is able to relate the data obtained from each sensing device (10) by aligning the data by using the time-stamp or the count marked in the data.

The disclosure includes as contained in the appended claims, as well as that of the foregoing description. Although this invention has been described in its preferred form with a degree of particularity, it is understood that the disclosure of the preferred form has been made only by way of example and that numerous changes in the details of construction and the combination and arrangements of parts may be resorted to without departing from the scope of the invention.

1. A system for analysing a stroking motion in a water sport comprising:
one or a plurality of sensing devices, each sensing device comprising at least one sensor for generating physical measurements of the stroking motion, the sensor being selected from the group consisting of an accelerometer, a force sensing resistor, a gyroscope and a magnetometer; and
a processor, in connection with the sensor, provided with a memory unit and a wireless communication module, wherein the processor is fashioned to receive a first signal through the wireless communication module to switch the sensing device in between a first operating mode and a second operating mode;
wherein in the first operating mode, the sensing device is configured to convert the physical measurements to metrics and immediately transmit the data relating to the metrics, whereas in the second operating mode, the sensing device is configured to, after the conversion, store the metrics in the memory unit first and then transmit the data of the metrics through the wireless communication module upon receiving a second signal;
a computing device provided with a mobile application for receiving the transmitted data of the metrics from the sensing device; and
a remote server capable of communicating with the mobile application to facilitate upload of the received metrics data to the remote server;
wherein the remote server is fashioned to compare the uploaded metrics to a set of values corresponding to predefined athletic data to produce results in terms of force used per time and to determine an optimised stroking motion.

2. A system according to claim 1, wherein the sensing device is secured on an athlete's finger or palm by using a fastening means.

3. A system according to claim 1, wherein the sensing device is secured on a paddling instrument.

4. A system according to claim 1, wherein the water sport is swimming, rowing, canoeing, kayaking or dragon-boating.

5. A system according to claim 1, wherein the sensing device further comprises a high pass filter configured to remove drifts from the data obtained by the accelerometer and the gyroscope.

6. A system according to claim 1, wherein the physical measurements are selected from the group consisting of acceleration, rotation and pressing force against water.

7. A system according to claim 1, wherein the sensing device further comprises an external power source for supplying electrical power to the processor.

8. A system according to claim 1, wherein the metrics are selected from the group consisting of stroke power, stroke angle, stroke length, moving speed and time to perform one cycle of stroking motion.

9. A system according to claim 1, wherein the computing device is a mobile phone, a tablet or a portable personal computer.

10. A system according to claim 1, wherein the mobile application is capable of displaying the metrics as well as visualised results and force profile derived from the metrics.

11. A system according to claim 1, wherein the athletic data are measurement data collected during an athlete's training sessions.

12. A system according to claim 1, wherein the athletic data are data corresponding to optimal movement for the water sport.

13. A system according to claim 1, wherein the remote server is a cloud server.

14. A system according to claim 1, wherein the sensing device and the mobile application respectively comprise a local real time clock, the real time clocks being calibrated to be in synchronization.

15. A system according to claim 1, wherein the real time clocks are configured to mark each physical measurement generated by the sensing devices with a time-stamp.

16. A system according to claim 1, wherein the wireless communication module is a Bluetooth module, a Bluetooth low energy (BLE) module, a WIFI module, an ANT module, an ANT+ module or a Zigbee module.

17. A system according to claim 1, wherein the sensing device is configured to transmit the data to a computing device when the force measured by a force sensing resistor is below a certain threshold.

18. A method for analysing a stroking motion in a water sport comprising the steps of
securing one or a plurality of sensing devices containing at least a force sensing resistor to one or a plurality of objects;
generating physical measurements of the pressing force against water of the stroking motion.

19. A method according to claim 18, wherein said securing includes securing the sensing device on an athlete's finger or palm by using a fastening means.

20. A method according to claim 19, wherein said analysing includes analysing a stroking motion in the water sport swimming

21. A method according to claim 18, wherein said securing includes securing the sensing device on a paddling instrument.

22. A method according to claim 21, wherein said analysing includes analysing a stroking motion in the water sports rowing, canoeing, kayaking or dragon-boating.

23. A method according to claim 18, further comprising the steps of
generating physical measurements of at least one factor selected from a group consisting at least out of acceleration, rotation and duration;
converting the physical measurements into metrics;
storing the data relating to the metrics in the memory unit;
transmitting the data relating to the metrics from the sensing device to a computing device provided with an application;
visualising the metrics and creating a force profile based on the metrics; and
displaying the metrics and the visualised metrics and the force profile on the computing device.

24. A method according to claim 23, wherein said generating includes passing the data obtained by the accelerometer and the gyroscope through a high pass filter to remove possible drifts.

25. A method according to claim 23, wherein said converting includes converting the physical measurements into metrics selected from the group consisting of stroke power, stroke angle, stroke length, moving speed, time to perform one cycle of a stroking motion, stroking cadence, proportion of the total value of power that is used for the propelling movement, and percentage of time that the stroking object is pressing against water.

26. A method according to claim 25, wherein said converting of physical measurements into metrics includes the steps of
generating physical measurements of the acceleration and the rotation of the stroking object;
adopting the processor to calculate the angle of the stroking motion;
resolving the pressing force against water of the stroking motion into three axes, one of which is along the axis of the movement of the object to which the sensing device is secured to and the other two axes perpendicular to the first axis;
adopting the processor to calculate the value for power being produced for each axis and the total value for power being produced; and
adopting the processor to relate the total value of power to the power along the axis of the movement of the object to gain the proportion of the total value of power that is used for the propelling movement.

27. A method according to claim 25, wherein said converting of physical measurements into metrics includes the steps of
generating physical measurements of the acceleration and the rotation of the object;
adopting the processor to resolve the acceleration of the stroking object into three axes, one of which is along the axis of the movement of the object to which the sensing device is secured to and the other two axes perpendicular to the first axis;
adopting the processor to calculate the value of displacement for each axis; and
adopting the processor to calculate the stroke length.

28. A method according to claim 23, wherein said converting of physical measurements into metrics includes the steps of
generating physical measurements of the rotation of the stroking object; and
adopting the processor to calculate the time the stroking object takes to perform one cycle.

29. A method according to claim 23, wherein said visualising includes the visualising of the power distribution of the stroking motion as an irregular shaped object in which the length of an axis represents the power exerted in the respective direction.

30. A method according to claim 23, wherein said creating includes the creating of a force profile displaying the force of the stroking motion as a graph of force against time.

31. A method according to claim 23, further comprising the steps of:
uploading the data related to the metrics from the computing device to a remote server;
comparing, on the remote server, the uploaded data to a set of values corresponding to predefined athletic data to produce results identifying weakness, strength or effectiveness of the stroking motion; and
determining an optimised stroking motion.

32. A method according to claim 31, wherein said uploading includes uploading the data related to the metrics to a cloud server and conducting the comparison there.

33. A method according to claim 31, wherein said comparing includes comparing the uploaded data to athletic data collected during a prior training session of an athlete.

34. A method according to claim 31, wherein said comparing includes comparing the uploaded data to athletic data corresponding to optimal movements for the water sport.

35. A method according to claim 31, wherein said identifying includes the comparing of force used over time, time, stroke angle, force amplitude and force profile.

36. A method according to claim 18, further comprising the steps of:
synchronising real time clocks within a plurality of sensing devices and the applications by a signal or signals sent via a computing device provided with an application;
generating physical measurements of at least one factor selected from a group consisting at least out of acceleration, rotation and duration;
marking each physical measurement generated by the sensing devices with a time-stamp;
converting the physical measurements into metrics;
storing the data relating to the metrics in the memory unit;
transmitting the data relating to the metrics from the sensing device to a computing device provided with an application;
aligning the metrics obtained from each sensing device;
visualising the aligned metrics and creating a force profile based on the aligned metrics;
displaying the aligned metrics and the visualised metrics and the force profile on the computing device;
uploading the data related to the aligned metrics from the computing device to a remote server;
comparing, on the remote server, the uploaded data to a set of values corresponding to predefined athletic data to produce results identifying weakness, strength or effectiveness of the stroking motion; and
determining an optimised stroking motion.

37. A method according to claim 18, further comprising the steps of:
generating physical measurements of at least one factor selected from a group consisting at least out of acceleration, rotation and duration;
converting the physical measurements into metrics;
transmitting the data relating to the metrics from the sensing device via the wireless communication module to a computing device provided with a mobile application when the force measured by a force sensing resistor is below a certain threshold;
visualising the metrics and creating a force profile based on the metrics;
displaying the metrics and the visualised metrics and the force profile on the computing device;
uploading the data related to the metrics from the computing device to a remote server;
comparing, on the remote server, the uploaded data to a set of values corresponding to predefined athletic data to produce results identifying weakness, strength or effectiveness of the stroking motion; and
determining an optimised stroking motion.

38. A method according to claim 37, wherein said transmitting includes transmitting the data relating to the metrics from the sensing device via a Bluetooth module, a Bluetooth low energy (BLE) module, a WIFI module, an ANT module, an ANT+ module or a Zigbee module.

39. A method according to claim 37, wherein said transmitting, displaying and uploading includes using a mobile phone, a tablet or a portable personal computer as a computing device.
